(19) United States
(12) Patent Application Publication
(10) Pub. No.: US 2007/0233717 A1
(43) Pub. Date: Oct. 4, 2007

(54) Generic product configuration framework for building product specific installers

(76) Inventors: Arvind Prabhakar, San Jose, CA (US); Rajesh Kumar Arcot, Sunnyvale, CA (US); Krishnendu Chakraborty, Foster City, CA (US)

Correspondence Address: HICKMAN PALERMO TRUONG & BECKER, LLP;AND SUN MICROSYSTEMS, INC., 2055 GATEWAY PLACE, SUITE 550, SAN JOSE, CA, 95110-1089, US

(21) Appl. No.: 11/377,784

(22) Filed: Mar. 15, 2006

(51) Int. Cl. G06F 7/00

(52) U.S. Cl. 707/101

(57) ABSTRACT

A generic product configuration framework is disclosed which utilizes a number of components to facilitate platform-independent configuration of installers and the installation of software products. The framework includes metadata, which defines actions, properties and characteristics for creating installers for software products. Two such types of actions include interactions to conduct with a user and tasks to be performed for installing the software product. The framework parses through the metadata and creates executable components for all the actions defined by the metadata, which are organized according to execution relationships specified within the metadata. When installation of a product is requested, the framework causes the executable components to be executed in the correct order, thus installing the software product according to the actions, properties and characteristics specified by the metadata. Further, the framework has the ability to rollback any changes made during installation in the case of any errors.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In order to install a software product on a computer system, a user must typically invoke an installer. The installer usually presents a graphical user interface, requests the user to provide some input, such as the desired location of the product, and installs the product in the desired location. Although this process may seem simple to the end-user, much time and effort is taken to actually create the installer that the end-user interacts with.

Software providers create installers customized for their own software products using product configuration tools. Because most software products have unique requirements, such product configuration tools are typically engineered to build installers suited for a single software product.

Accordingly, one drawback of existing product configuration tools is their product and platform specific dependencies. For instance, most product configuration tools are designed on a specific set of product requirements and standards and cannot be used for more than one product without substantive reconfiguration and effort. The particular software product may need to be configured differently on different platforms such as applications servers or operating systems. When a new software product is developed, a new product configuration tool must be developed in order to install that software product. The scenario is worse for installing and configuring multiple products across multiple platforms. Further, the problem with attempting to create a generic installer is a loss in granularity for configuring specific products. No framework exists which can support multiple products across multiple platform, and at the same time maintain the granularity to adapt to specific software products.

### SUMMARY

In accordance with one embodiment of the present invention, there is provided a generic product configuration framework. The generic product configuration framework uses a number of components which work together on a system to facilitate the configuration of installers and the installation of software products.

The generic product configuration framework includes a set of metadata which defines properties and characteristics for software installers. In order to create software installers, the set of metadata is created to identify characteristics and properties for installation, including information identifying interactions to conduct with a user and tasks to be performed to configure the software product.

In order to be fully generic across many platforms and software products, the metadata identifies two categories of elements common to installations. These categories include interaction elements and task elements. The interaction elements define interactions that are to be conducted with a user to obtain user-input. Examples of such user interaction include requesting the user to specify the location to install the software product, as well as other user specified information. Interaction elements within the metadata may also specify actions to perform against user-input received in response to performing an interaction. These actions are referred to as validations, and some interaction elements may include validator elements for creating validations for the user-input.

The metadata also contains task elements, which define actions for the system to take in order to install the software product using the generic product configuration framework. The task elements include information identifying properties and characteristics for creating task components for execution by the system.

For each of the metadata elements, the generic product configuration framework causes executable components to be created for execution by the system. The executable components are organized into an execution data structure according to execution relationships specified in the metadata that specifies the order and manner of executing the executable components in order to install a software product. Thus, when the generic product configuration framework is invoked to install a software product, the framework executes the components according the execution relationships specified within the execution data structure.

When a software provider would like to create an installer for a software product, the generic product configuration framework allows the software provider to customize any portion of the installation according to the unique requirements of the software product. For instance, the software provider may create custom interactions and tasks by modifying the metadata that identifies the interactions and tasks. Further, if any of the interactions or tasks require classes that may not be provided with a system, the software provider may define any custom classes it wishes to provide. These custom classes may be referenced by the metadata and be used by the generic product configuration framework to create executable components.

When installation of a product is requested, the generic product configuration framework causes the executable components to be executed in the correct order, thus installing the software product according to the properties and characteristics specified by the software provider. According to on embodiment, the executable components are created and executed in a platform independent programming language such as the Java® programming language by Sun Microsystems, Inc. Further, during the installation of any software product, the generic product configuration framework may be used to track the progress of the installation. At any point during installation, information regarding each stage of the installation may be stored for later reference.

Thus, the generic product configuration framework may manage the state of an installation, and has the capability to determine if a product is being installed for the first time or if a new instance of the same product is being configured. Depending on whether the product is being installed for a first time or if a new instance is being configured, the framework decides on which interactions and/or tasks to execute. Further, the generic product configuration framework may use such information to debug any errors during installation or to provide support for the un-installation of the software product.

Because the generic product configuration framework is not tied to any particular program, the same framework may be used on a single system to track installation of multiple software programs, as well as multiple installations of the same software program. Thus, the generic product configuration framework is actively involved in monitoring a software product across multiple clients. Further, according to one embodiment, the generic product configuration framework includes multiple system tools, such as the generation and encryption of passwords, the debugging of errors within software programs, the listing of product instances configured by the framework and user-license management.

Using the metadata, the generic product configuration framework may be customized to build installers for many software products across many platforms. All that is required is that the metadata be customized and that any custom classes for creating executable components be provided. In this manner, the generic product configuration framework may be customized at any level of granularity, and may be adapted to any number of different products and platforms. Because of the granularity at which customizations can be made for different products and platforms, the generic product configuration framework drastically decreases the time and effort required for creating new installers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is an overview of a system in which one embodiment of the present invention may be implemented;

FIG. 1B is an overview of a communication system on which one embodiment of the present invention may be implemented;

FIG. 2 is a flow diagram illustrating a method for configuring a product using a generic product configuration framework according to one embodiment of the present invention;

FIG. 3A is a block diagram illustrating an overview of metadata for configuring a product using a generic product configuration framework according to one embodiment of the present invention;

FIG. 3B is a block diagram illustrating an overview of configuration metadata specifying one or more configuration instructions for configuration a product according to one embodiment of the present invention;

FIG. 3C is a block diagram illustrating interaction metadata specifying one or more interactions to conduct with a user according to one embodiment of the present invention;

FIG. 3D is a block diagram illustrating task metadata specifying one or more tasks to perform for configuring a product according to one embodiment of the present invention;

FIG. 4A is a flow diagram illustrating a method for creating executable interaction components from interaction metadata according to one embodiment of the present invention;

FIG. 4B is a flow diagram illustrating a method for creating executable task components from task metadata according to one embodiment of the present invention;

FIG. 5 is a block diagram illustrating multiple configuration scenarios is shown according to one embodiment of the present invention;

FIG. 6A is a flow diagram illustrating the execution of an Interaction component is shown according to one embodiment

FIG. 6B is a flow diagram illustrating the execution of a task component is shown according to one embodiment

FIG. 7 is a block diagram that illustrates a computer system 700 upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Structural Overview

The present invention is embodied in a generic product configuration framework, which may be provided with a software product for installation on a system. According to one embodiment, the generic product configuration framework is an entity separate from the software product itself and may be used to install and configure multiple software products on a single system. The generic product configuration framework may be installed on a particular system and used for multiple software installations on the same system.

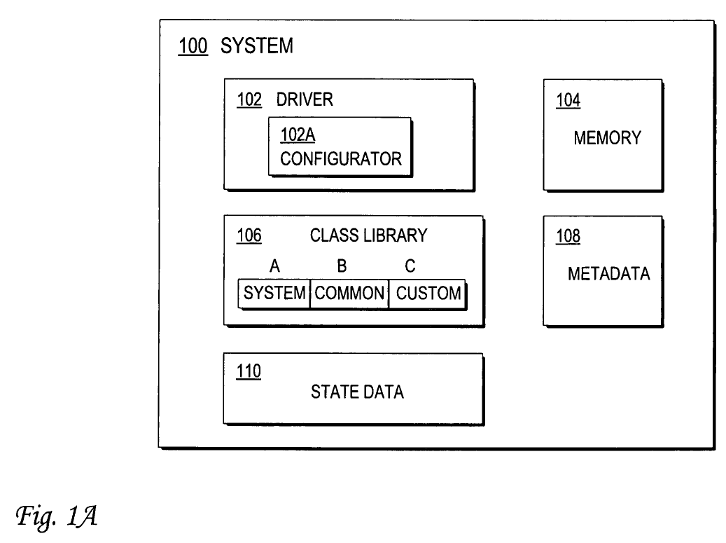

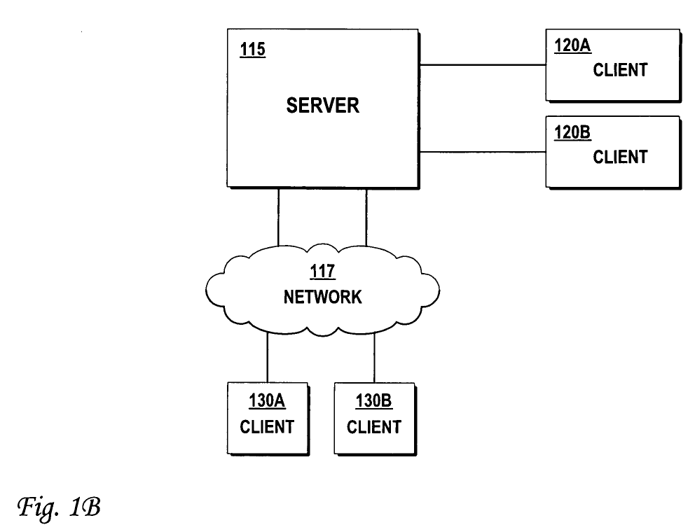

Referring now to FIG. 1, a System 100 containing a generic product configuration framework is shown in accordance with one embodiment. System 100 includes a Driver 102, Memory 104, Class Library 106, Metadata 108 and State Data 110. Together, the components of System 100 are used by the generic product configuration framework to install and configure software products. Note that although these components are shown as being part of System 100, the components of System 100 may be dispersed among numerous systems in various locations. Further, the components of System 100 may be controlled with various mechanisms. For instance, according to one embodiment, a user may control the components of System 100 through a graphical user interface shown on a display connected to System 100. Further, the components of System 100 may be web based such that the generic product configuration framework may be used as a web application over the Internet or a Local Area Network.

According to one embodiment, Driver 102 is responsible for controlling the operation of the generic product configuration framework. Driver 102 executes components for installing and un-installing products, keeps track of product installations for multiple clients and performs other tasks in conjunction with the framework. More specifically, by executing the components, Driver 102 causes interactions to be conducted with a user wishing to install a software product. When a user responds to the interactions, Driver 102 collects, validates and stores the user-input for later use. Further, by executing the components, Driver 102 calls one or more task handlers to configure common and instance specific installations on a server. Throughout the product configuration process, Driver 102 caches information related to the installation of a product for future use and reference.

Driver 102 includes Configurator 102A, which processes Metadata 108 and creates executable components for storage in Memory 104. The executable components are executed by Driver 102 to install or un-uninstall a product. An executable component contains one or more sets of executable instructions, which when executed by one or more processors, cause the processors to perform one or more operations on System 100. In one embodiment, the executable components are instances of Java objects created from Java classes and the instructions are written in Java bytecode. In other embodiments, however, the executable components may be in any form that may be executed by one or more processors on a computing system.

While creating executable components, Configurator 102A utilizes Class Library 106. A class library is a collection of classes for creating executable components. A class describes the rules and properties by which objects, or “instances” of that class should adhere to. For instance, the class library may define Java classes for creating instances of Java objects. According to one embodiment, a class specifies the structure of data which each instance contains as well as the functions which manipulate the data of the object and perform tasks.

For the purposes of organization, Class Library 106 may be further defined into class subsets A, B, and C, which are specifically referenced by the components of System 100. For instance, subset A may include “System” classes, which define those classes pre-configured on or provided with system 100. Such classes may include classes which were provided before installation of the generic product configuration framework. Subset B includes “Common” classes defining those classes that are used by multiple components or products of System 100. For instance one common class may be a class defining user-interface objects that are used by various programs on System 100. Subset C includes “Custom” classes, which are those classes created and defined by a third party or user of System 100.

According to one embodiment, when a third party would like to customize the installation of a particular software product, the third party may create custom classes for defining custom interactions and tasks to be executed by Driver 102. To customize the configuration and installation of any particular software product, the third party would provide the custom classes, configure Metadata 108 to reference the custom classes and provide the software program resources for System 100. When Configurator 102A parses through Metadata 108, one or more elements will make reference to the custom classes, and Configurator 102A will create executable components using those custom classes.

When Configurator 102A creates executable components, Configurator 102A verifies that the executable components adhere to the characteristics or properties specified for classes in the Class Library 106. In order that Driver 102 executes the correct components in the correct order, Configurator 102A also organizes the executable components in Memory 104 according to execution relationships specified in Metadata 108. Note that while Configurator 102A is described as being a part of Driver 102, in other embodiments Configurator 102A may be a separate component of System 100.

When installation of the software program is requested, for instance, by a user/client of System 100, Driver 102 is invoked to execute the executable components. Driver 102 retrieves the executable components in memory for execution.

During the operation of the generic product configuration framework, Configurator 102A is responsible for processing Metadata 108 and creating executable components. Once the metadata has been processed, Driver 102 becomes responsible for executing the executable components and is responsible for configuring and installing the program.

Metadata 108 contains a structured set of elements which define properties and characteristics for the installation and configuration of a software product. Configurator 102A uses the elements to create executable components. According to one embodiment, Metadata 108 is a text document written in the Extensible Markup Language (XML), which contains the configuration information for creating product installers. The metadata may be written by a human programmer. In fact, the metadata may be easily customized and adapted for many different products, assuming that the metadata adheres to some general template for creating product installers. Thus, a third party wishing to create an installer for a product may access the metadata using a text editor to specify characteristics of the installer, such as the availability and location of any custom classes as described above. These characteristics may be embodied in the form of metadata elements.

According to one embodiment, two types of elements are required to be defined by the metadata in order to create an installer for a software product: (1) elements which define interactions to conduct with a user, hereinafter referred to as Interaction elements, and (2) elements which define tasks for the installer to perform, hereinafter referred to as Task elements.

Interaction elements specify characteristics that define interactions to conduct with a user during the installation process. Task elements specify tasks or actions to be performed during the installation process. Further, Metadata 108 also specifies relationships between interaction and task elements which Configurator 102A uses to construct executable components.

System 100 also includes State Data 110. State Data 110 is created by Driver 102 and is used to maintain information regarding prior installations of products by the generic product configuration framework. For instance, when a product is first installed, State Data 110 may be used to indicate the location of the product on System 100, as well as any unique properties or characteristics for the particular installation. Thus, using State Data 110, the system may offer additional functionality such as user-based license checks for multiple users of the same product, the creation of a unique key that identifies each run of the installer multiple times, and also the ability to share common data across multiple installation runs.

Further, State Data 110 may be used to track installation progress and errors during the installation process. For instance, while Driver 102 is proceeding with installation, it may periodically store data relating to the installation to preserve critical installation data. Thus, at any stage during installation, State Data 110 is stored at a location of System 100 so that Driver 102 can quickly access information regarding the installation. According to one embodiment, Driver 102 keeps track of configuration information by storing the information in Memory 104. Once a particular phase of the installation has completed, such as conducting all identified interactions with a user, Driver 102 will take a “snap shot” of the information in Memory 104 and store the information as State Data 110 on System 100. Further, because Driver 102 may be invoked to install the same program for multiple clients in different locations on the same System 100, Driver 102 can store State Data 110 for each install in an appropriate system directory.

Referring now to FIG. 1B, a system implementing a generic product configuration framework is shown in accordance with one embodiment. The system includes Server 115 and Clients 120A, 120B, 130A and 130B. According to one embodiment, Clients 120A and 120B may be directly connected to Server 115, while Clients 130A and 130B may be devices connected to Server 115 via Network 117. Network 117 may be implemented by any medium or mechanism that provides for the exchange of data between devices. Examples of Network 117 include, without limitation, a network such as a Local Area Network (LAN), Wide Area Network (WAN), Ethernet or the Internet, or one or more terrestrial, satellite or wireless links. Through Network 117, Server 115 can communicate with Clients 130A and 130B.

According to one embodiment, Clients 130A and 130B represent two distinct users of Server 115. Using the generic product configuration framework, Server 115 can track installations of the same product or program for Clients 130A and 130B. The generic product configuration framework can track multiple installations for multiple clients on the same system. This is useful for tracking product licenses among multiple users of the same machine. For instance, Driver 102 can track installations of the same product on Server 115 by each Client 120A, 120B, 130A and 130B. Further, Driver 102 can selectively uninstall a product for Client 120B, for instance, without affecting product configurations for Clients 120A, 130A or 130B.

For example, assume Client 120A would like to install a product for the first time on Server 115. When Client 120A invokes the installation file for installing the product, the generic product configuration framework is installed on Server 115. Once the generic product configuration framework is installed, Driver 102 may be invoked to install the product for Client 120A. During installation, Driver 102 stores installation data common to any installation, as well as data specific for Client 120A. For instance, Client 120A may have a particular user name different from Client 120B. Also, Clients 120A and 120B may require a different configuration for a particular product because they are connected to Server 115 across a Network 117. Thus, Driver 102 can track and store configuration information relating to multiple installations on the same Server 115.

When Client 130A would like to install the same product as Client 120A on Server 115, the generic product configuration framework will already be in place, and Driver 102 will determine that the product has already been installed for a different client on Server 115. To install the product for Client 130A, the installation may be customized such that the product is installed in a different location of Server 115 or that the installation uses different parameters or characteristics as described in further detail herein.

### Functional Overview

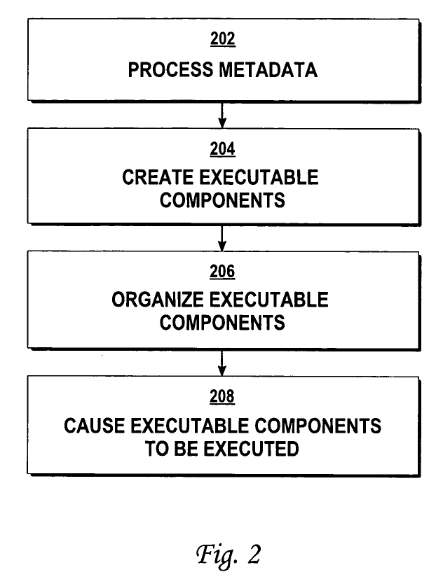

According to one embodiment, when System 100 is invoked to install a software product, control passes to Driver 102, which utilizes the components of System 100 to configure and install the software product. Referring now to FIG. 2, a flow diagram illustrating a method for configuring a product using a generic product configuration framework is shown according to one embodiment. At step 202, Driver 102 processes metadata by, for instance, locating Metadata 108, which may be located on a storage device of System 100. Once Driver 102 has located Metadata 108, Driver 102 invokes Configurator 102A to read and parse through the contents of Metadata 108. At step 204, Configurator 102A parses through Metadata 108 and creates executable components based on the contents of Metadata 108.

Metadata 108 contains Interaction elements and Task elements. When Configurator 102A is parsing through Metadata 108, it reads the Interaction elements and creates executable Interaction components, which Driver 102 executes during the installation of a software program. The Interaction elements defined by Metadata 108 reference callback mechanisms used by Driver 102 to configure common or instance-specific interactions during installation.

When Interaction components are executed by Driver 102, according to one embodiment, a prompt requesting user-input is displayed to a user at a display screen. When the user-input is received it may be validated by Driver 102. According to on embodiments, Driver 102 validates user-input by executing one or more Validator components. The validator components are defined by Validator elements in Metadata 108, which identify validations to perform on user-input in response to executing Interaction components. Much like the Interaction elements of Metadata 108, Configurator 102A constructs executable Validator components for Driver 102 to execute in order to validate user input.

Further, Configurator 102A also creates Task components from Task elements defined in Metadata 108. The Task elements of Metadata 108 define actions that Driver 102 or System 100 must perform in order to install a software product. The Task elements defined by Metadata 108 reference callback mechanisms used by Driver 102 to configure common or instance-specific changes during installation. According to one embodiment, the callback mechanisms referenced by Metadata 108 are instances of objects created from classes defined in the Class Library 106. For example, a task element may define an action such as the copying of files onto a storage device of System 100. Accordingly, the task element metadata will reference an instance of an object for copying files from one location to another. Thus, Configurator 102A creates Task components for execution by Driver 102 based on Task elements defined in Metadata 108.

While creating executable components, at step 206, Configurator 102A organizes the executable components into an execution data structure according to execution relationships specified within Metadata 108. According to one embodiment, Metadata 108 specifies the order in which interactions are to be conducted and in which tasks are to be executed to install the software product on various systems. Further, Metadata 108 may also define dependencies between Interaction and Task components. For instance, Metadata 108 may specify that data received in response to executing a particular interaction component will be needed during the execution of a particular task component. Hence, Metadata 108 may specify not only the order of executing particular components but also execution relationships between the components required to install a product. Using these execution relationships, Configurator 102A constructs and organizes executable components into an execution data structure for execution by Driver 102.

Once Configurator 102A has processed all information of Metadata 108 and created and organized the executable components, at step 208, Driver 102 causes the executable components to be executed by processing the execution data structure. According to one embodiment, the execution data structure is an executable Java program written in bytecode for execution by a Java Virtual Machine (JVM), and Driver 102 installs and configures a software product by causing a JVM on System 100 to execute the Java program.

b. Product Configuration Metadata

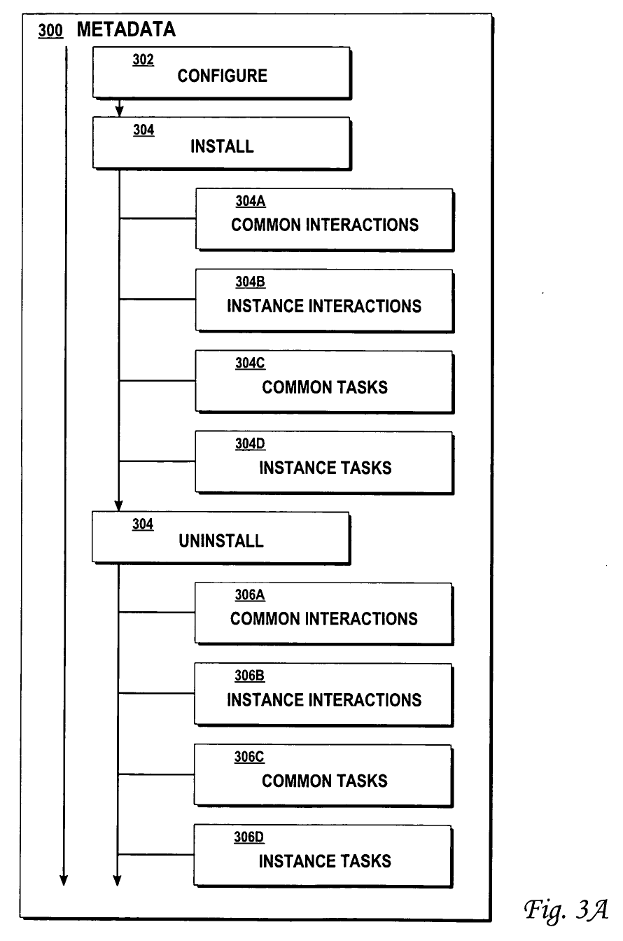

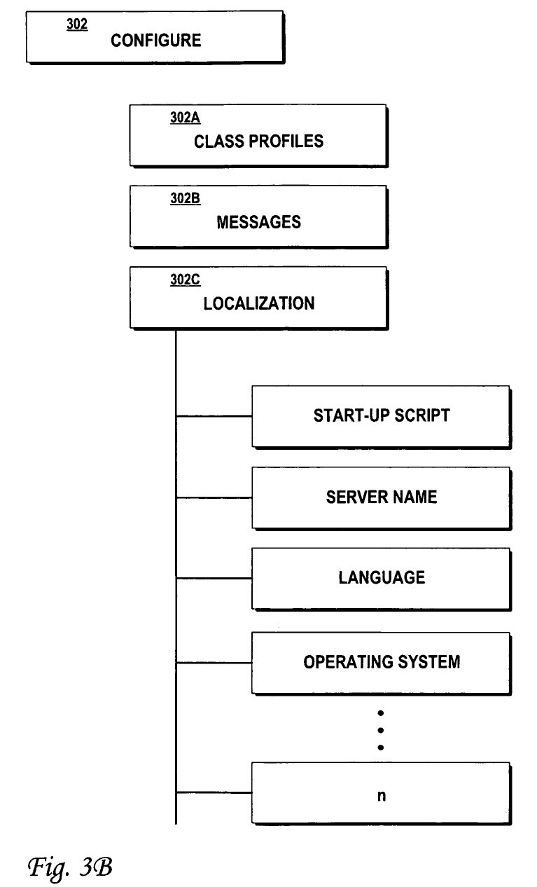

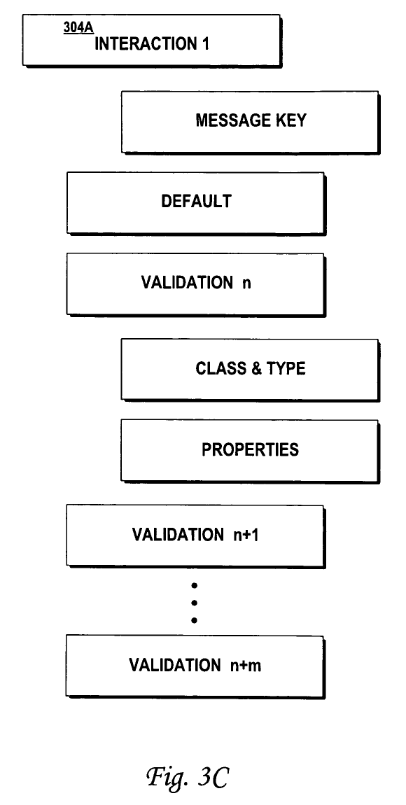

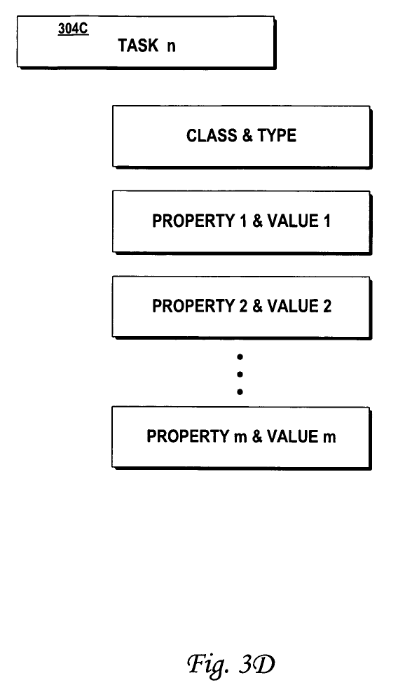

Referring now to FIG. 3A, a block diagram illustrating the structure of Metadata 300 is shown. Metadata 300 contains metadata elements which define attributes and characteristics for creating an installer for a software product. For instance, according to one embodiment, the metadata elements define interactions to conduct with a user and tasks to be performed for installing and configuring a software product. These metadata elements are organized into Metadata 300 for use by Configurator 102A in constructing executable components for installing the software product.

According to one embodiment, Metadata 300 is organized into three category elements, namely Configure element 302, Install element 304 and Uninstall element 304. Note, however, that in other embodiments the metadata may be organized in any manner and contain any number of elements. Each category element includes a number of sub-elements which further define properties for the installation and which will be discussed in further detail below.

The metadata for the Configure element 302 identifies information for use by Configurator 102A while preparing executable components for execution by Driver 102. For instance, Configure element 302 may include information identifying the location of Class Library 106, including reference to specific class packages such as common, system or custom class packages. The metadata for Install element 304 defines Interactions 304A-304B to conduct with a user, as well as Tasks 304C-304D to perform for installation. Further, the metadata for Uninstall element 304 also defines any Interactions 306A-306B or Tasks 306C or 306D to perform during the un-installation of any instance of a product on System 100.

FIG. 3B depicts Configure element 302 of Metadata 300 with more detail according to one embodiment. Configure element 302 contains information for preparing and pre-configuring the installation of the product. For instance, according to one embodiment, the Configure element 302 lists Class Profiles 302A, Messages 302B and Localization information 302C for installation of a product. The Class Profiles 302A may indicate the location of any class libraries on system 100, such as Class Library 106 in FIG. 1A. Using the Class Profiles information 302A, Configurator 102A identifies the location of particular class libraries for constructing executable components from metadata.

Messages information 302B contains information for displaying messages during the configuration of the installer. According to one embodiment, the messages may indicate an initial start-up message for a user of the generic product installation framework, and may simply be a “welcome” message. Alternatively, the messages information may refer to standard response messages to display at a user-interface during the installation of a product. Also, Messages information 302B may define messages specific to the generic product configuration framework which are not connected with the installation of any product. For instance, when the generic product configuration framework is invoked on system 100 for a first time, a message may be displayed to a user of system 100 requesting that the user identify himself. Further, such a message may request that the user input data identifying the operating system of system 100, as well as any native languages to use during any installation.

Localization information 302C contains information about the native environment of system 100. Such information may be, for instance, previously obtained from a user by Configurator 102A during the initial installation of the generic product configuration framework. Once this information is obtained, Localization information 302C maintains a record of the data.

Localization information 302C may indicate, depending on the native environment of system 100, the server name, language and operating system that Driver 102 or Configurator 102A is currently operating on. This information is used by Configurator 102A to customize particular characteristics of installation for particular platforms. Thus, for instance, if the framework were to be operating on a Windows OS platform, the particular location of files, default folders or other characteristics may be different from the same characteristics running on a Solaris OS based machine. In this case, the Localization information 302C allows the Configurator 102A to self-discover which type of platform it is running on and adjust properties for installation accordingly. Further, Localization information 302C allows the Configurator 102A to discover the language that should be used to display messages to a user, including any other language or native characteristics to be used during the installation of a software product.

FIG. 3C depicts an Interaction element 304A of Metadata 300 with more detail according to one embodiment. According to one embodiment Interaction 304A identifies one or more interactions to conduct with a user during the installation of a product. For instance, one interaction may request particular user input, which is then used by the Configurator 102A to construct task components according to task metadata. In some instances, the interaction may require a particular message to be displayed to the user. Hence, according to one embodiment, the Interaction metadata 304A also contains a Message Key identifier, which corresponds to a message for display to a user during the installation process.

According to one embodiment, the Message Key identifier is an i18n key corresponding to a message for display. An i18n key is an internationalization standard used for adapting products across non-native environments. More specifically, i18n is used where a particular software product will be configured to adapt to many languages. Instead of creating a separate program for each language, the i18n message keys themselves are placed into the software program. Messages corresponding to the i18n message key may be stored in a number of message files, each file corresponding to a different language. The message files are used to associate the message keys with particular messages. When the software program becomes aware of its locale, it finds the correct message file and populate the message within the program at runtime. According to one embodiment, Configurator 102A uses Localization information 302C, as described earlier, to determine which language and message file to use for associating messages with message keys.

Thus, instead of placing a message in the interaction component, Configurator 102A may place the message key inside the component. Upon execution of the interaction component by Driver 102, Driver 102 will recognize the message key, look up the corresponding message file and populate the message at runtime.

Further, Interaction element 304A may define a default value for the interaction. Thus, in the case that no user input is required or received, Interaction element 304A may report the default value instead of any user-input value in response to the interaction at runtime. In other embodiments, Interaction element 304A does not contain a default value, meaning that a user-must respond to the interaction with user-input or receive a standard error message as defined in Configure element 302.

Next, Interaction element 304A may further specify Validation information for validating user input received in response to an interaction which requests the user input. The Validation information is used by Configurator 102A to create Validation components, which are executed to validate and verify user-input received from a particular interaction.

According to one embodiment, a standard set of Validation components may be provided. For example such Validation components may include whether a specified directory is valid, whether a file is readable or writable, whether a hostname exists, whether a port is valid, and other validation tests for validating input data. For instance, one interaction may request that the user input a particular number value. In this scenario, one Validation component may test the input to determine if the user has in fact entered a number. If the user has not entered a number, the Validation component returns an error. Note that any single Interaction element may specify multiple validations to perform against user-input or data.

After Configurator 102A has completed processing the interaction elements in Metadata 300, Configurator 102A begins to parse through any Task elements 304C in Metadata 300. Task elements 304C define actions to be taken by Driver 102 in order to install the software product.

FIG. 3D depicts the Task element 304C of Metadata 300 with more detail according to one embodiment. Task element 304C includes reference to a particular class name and the type of the class for use in constructing an executable component. For instance, the class name may be a reference to a particular class, such as a Java class for performing a specific action on System 100. The type of the class may indicate whether the class is defined as a system, common or custom class. Thus, using the type indicated in Task element 304C, Configurator 102A can create the correct executable component by referring to Class Library 106.

Further, Task element 304C includes reference to one or more properties and values to be utilized by an executable task component to perform the specified action on System 100. According to one embodiment, the properties are translated into parameters or variables of the executable component. According to one embodiment, the property values are user defined. For instance, suppose that an interaction called for a user name to be requested. The user's name may be allocated a property name of “USER_NAME_-KEY” within Task element 304C and the value may be labeled “USER_NAME.” Further, suppose that a particular Task component made reference to “USER_NAME_KEY”, such that when the task was executed, the task would require the particular value “USER_NAME” in order to proceed.

When Driver 102 requests the user name during installation, it receives the user name value, validates it and stores the value in memory. When Driver 102 executes the executable task component which makes reference to the user name value, Driver 102 will lookup the property name and value in memory and populate the placeholders within the task component. Thus, for instance, suppose an interaction requests a user name from the user. When the user input is received and validated by Driver 102, Driver 102 assigns the user input value to the property “USER_NAME_KEY.” Hence, when reference is made by the particular task component to “USER_NAME_KEY,” the value entered by the user will be used.

According to one embodiment, Task elements may be customized and defined by a user in order to customize specific tasks or changes to be handled by Driver 102 during the installation of a product.

c. Configurator Operation and Pre-Processing of Metadata

Suppose a software product supplier would like to create an installer which uses the generic product configuration framework. In order to customize the installation of any software product, the supplier will simply need to customize the metadata to specify the specific interactions and tasks that need to be executed for installation. According to one embodiment, the supplier can utilize classes within Class Library 106 to act as a reference while customizing the metadata. However, alternatively, the supplier may wish to create a custom class for creating an executable component from the metadata.

On system 100, the generic product configuration framework is installed. Once the metadata is customized and any custom classes are provided, Configurator 102A may proceed to create the executable components which represent the installer for the software product.

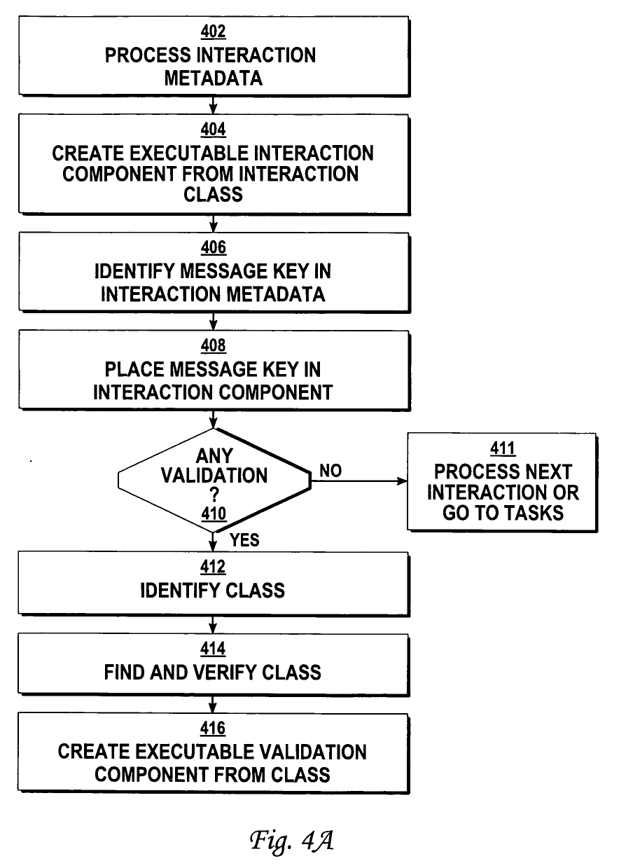

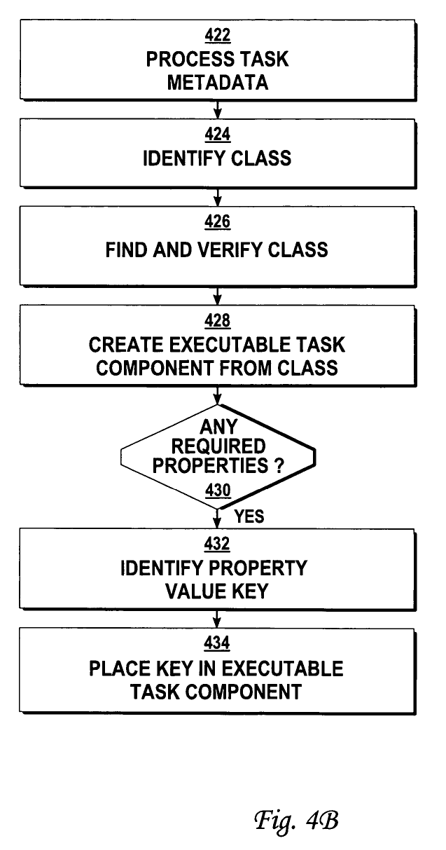

Referring now to FIG. 4A, a flow diagram illustrating a method for creating executable interaction components from interaction metadata is shown according to one embodiment of the present invention. According to one embodiment, Configurator 102A pre-processes Metadata 300 by parsing through each metadata element and creating executable components, which are in turn executed by Driver 102 to install the product.

At step 402, the Configurator 102A processes the interaction metadata by parsing through each element or information contained within Interaction element 304A, for instance. Next, at step 404, Configurator 102A creates executable interaction components based on the information identified in the interaction-metadata. According to one embodiment, all interactions are constructed using a common interaction class in the Class Library 106. The common interaction class may provide placeholders for interaction messages, including instructions for displaying messages to a user using a graphical user interface or text. Thus, Configurator 102A creates executable interaction components by inserting information located in the interaction metadata into the placeholders defined by the interaction class to create an executable interaction component. Specifically, at step 406, Configurator 102A places the message key identified in the Interaction metadata 304A into the executable interaction component.

Next, at step 410, Configurator 102A determines if any validations are required for the interaction by examining the Interaction metadata 304A as described in detail above. If no validations are listed, the process proceeds to step 411, where Configurator 102A begins to process the next interaction listed in Metadata 300 or proceed to creating executable components for tasks listed in Metadata 300.

If, however, validations are listed for a particular interaction, at step 412, Configurator 102 examines the validation information to determine which class the validation will be created from. In one embodiment, Configurator 102A examines classes located in the Class Library 106 to determine if the listed class is available. Thus, at step 414, Configurator 102A finds and verifies the class specified in the validation information of Interaction metadata 304A. Once the class has been found and verified, Configurator 102A creates an executable validation component from the identified class.

Referring now to FIG. 4B, a flow diagram illustrating a method for creating executable task components from task metadata is shown according to one embodiment of the present invention. Once Configurator 102A has completed creating the Interaction components from Interaction elements in Metadata 300, at step 422, Configurator 102A begins to process each Task element 304C of Metadata 300. In order to create an executable Task component, Configurator 102A first identifies the class associated with the Task element at step 424. Recall that each Task element 304C contained reference to a class in Class Library 106 for creating executable components. At step 426, Configurator 102A finds and verifies that the specified class exists in Class Library 106. If the class does not exist, Configurator 102A may cause a message to be displayed to a user attempting to install the software product. Alternatively, Configurator 102A may log the error in Memory 104, and the log of the error may be used to help a programmer debug the installer.

If the class is found and verified, at step 428, Configurator 102A creates an executable task component using the characteristics and attributes of the specified class. While creating the executable task component, at step 430, Configurator 102A also determines if any properties are required for the executable task component to function properly. If so, at step 432, Configurator 102A identifies the property value key corresponding to the property required by the executable task component. For instance, suppose the executable task component might require user-data corresponding to a user name. According to one embodiment, the user-name is assigned a property value key of “USER_NAME_KEY,” and the actual value of the user name is assigned to the key during execution of an Interaction component. Hence, the key “USER_NAME_KEY” is identified within Task element 304C, and at step 434, the property value key is placed within the executable task component. When the executable task component is executed, the property key value “USER_NAME_KEY” is replaced with the actual property value of the user name, which may have been obtained during the execution of an interaction components.

d. Installation Flows

A single generic product configuration framework may be used to install multiple software programs on system 100. Further, the same generic product configuration framework may be used to install the same software program for multiple clients of system 100. Thus, in the case of Server 115, a single software program may be installed by each Client 120A-B and 130A-B in different locations and using different properties or parameters. According to one embodiment, each installation or un-installation of a software product on system 100 provides a separate scenario for the generic product configuration framework.

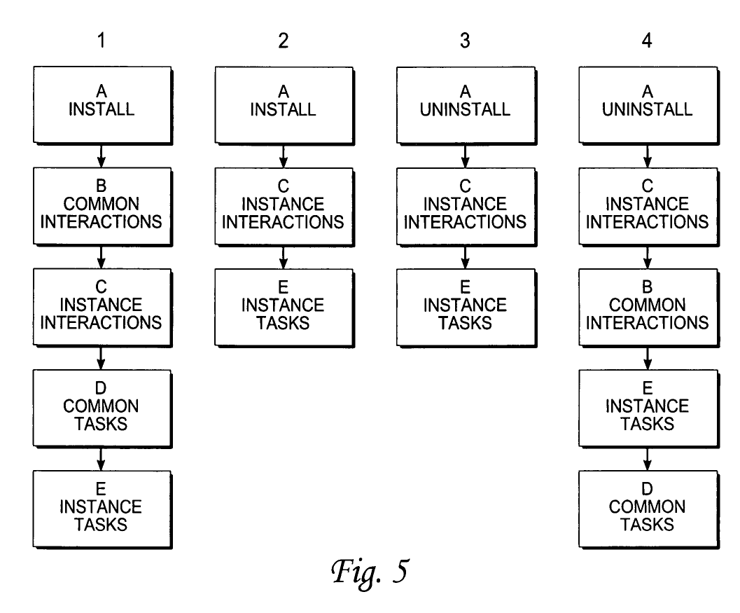

Referring now to FIG. 5, a block diagram illustrating multiple configuration scenarios is shown according to one embodiment. FIG. 5 shows Scenarios 1 and 2, which correspond to two different installation scenarios, and Scenarios 3 and 4, which correspond to un-installation scenarios.

Scenario 1 represents the flow of Driver 102 during the first installation of a software product on system 100. According to one embodiment, Driver 102 invokes the executable components needed to install the software product, which were previously created and placed in memory by Configurator 102A. To begin the installation of a software product on system 100 for the first time, Driver 102 runs through component groups B, C, D and E. Each component group represents a set of executable components for execution by Driver 102. Component group B includes common interactions for requesting user input. A “common” interaction component defines an interaction that will request user-input that will be common among all installations of the software product on system 100. The data retrieved from the common interactions in group B will be common among all installations of the product for the same system by different clients. In this manner, any common interaction components will only be executed the first time the software product is installed on system 100. Next, any instance-specific interactions are executed by Driver 102. Instance specific interactions, defined by group C, are those interactions which request data that will be specific to the particular installation of the software product by a particular client. In this manner, any instance-specific interactions will be executed whenever the software product is installed.

Next, Driver 102 executes the components of group D, representing the common tasks to perform on system 100 for installing and configuring a software product. Like the common interactions of group B, the common tasks of group D define tasks that only need to be performed for the initial installation of the software product on the system. To complete the installation, Driver 102 executes components of group E, representing the instance-specific task components of the installation.

After installing a software product on system 100 for a first time, State Data 110 will indicate that the software product has been installed, including the location of the software product and any properties or characteristics specific to the installation. According to one embodiment, one such characteristic may be a client ID identifying the specific client which requested the installation. When Driver 102 is invoked once again to install the software product on system 100, Driver 102 can query State Data 110 to determine if the software product has already been installed for the same client on system 100.

Scenario 2 represents the flow of Driver 102 during a subsequent installation of a product on a system. According to this scenario, the same product was already installed on the system by a different client. Alternatively, the same client may be attempting to install the same product twice on the same system, but in different locations. This situation is more common in a client-server system, where multiple clients are installing programs on the same server. Accordingly, Driver 102 determines whether a software product is being installed on system 100 for a second time by a different client by querying State Data 110. During the installation of the product for a second client, for instance, Driver 102 will only execute interaction specific components, such as the components represent by groups C and E representing instance-specific interactions and tasks.

When un-installation of a software product is requested, the process of installation in Scenarios 1 and 2 is essentially reversed. When a particular client requests that a software product be uninstalled on system 100, Driver 102 is invoked to perform the appropriate actions. According to one embodiment, before uninstalling a software product, Driver 102 determines if all instances of a software product are to be un-installed from system 100 or only a specific instance for a particular client. For instance, Driver 102 can query State Data 110 to determine that a software product is installed for multiple clients on system 100. Thus, as represented by Scenario 3, Driver 102 will only execute components of group B and C, representing instance specific interactions and tasks to execute for un-installing a single instance of the software product from system 100.

Further, during un-installation of a software product, Driver 102 uses State Data 110 to determine what actions to take to remove the software product from system 100. For instance, according to one embodiment, State Data 110 includes information identifying the location of the software product on system 110, as well as a detailed account of the actions taken to install the software product. Hence, Driver 102 may use State Data 110 to roll-back any of the actions taken during installation to un-install the software product.

Alternatively, as described in one embodiment above, Metadata 300 includes Uninstall element 306, which defines interactions to be conducted and tasks to be performed during the un-installation of a software product. Thus, Configurator 102A will have previously created executable component groups for un-installing the software product, and Driver 102 will execute the appropriate group of executable components to un-install the software product.

Assume that an administrator of system 100 would like all instances of a software product to be removed from system 100. According to one embodiment, Driver 102 recognizes that the administrator of system 100 has invoked the generic product configuration framework to un-install the software product. In this instance, Driver 102 may initially execute an interaction component which queries whether all instances of the software product are to be removed from system 100.

Hence, Scenario 4 represents the removal of all instances of a software product on system 100. Alternatively, Scenario 4 represents the removal of the last remaining instance of the software product on system 100. Using an uninstall process, in Scenario 4, Driver 102 will perform a “rollback” of any operations during the install process in component groups C, B, E and D, respectively. Note, however, that the order of un-installation in Scenario 4 may be different from the order of installation in Scenario 1. For instance, Driver 102 may cause any instance-specific interactions to be executed before common interactions and instance tasks before common tasks. In this manner, the generic product configuration framework can ensure that all instance-specific changes are made without affecting any system wide settings for the software product. However, the invention is not limited to such an embodiment, and Driver 102 may use any appropriate order of execution to un-install a software product from system 100.

e. Running Installations

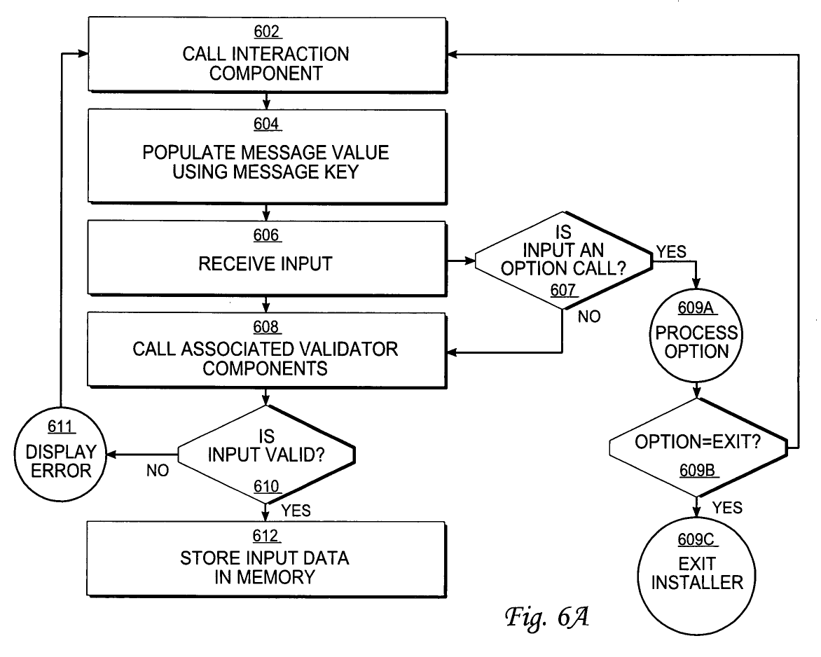

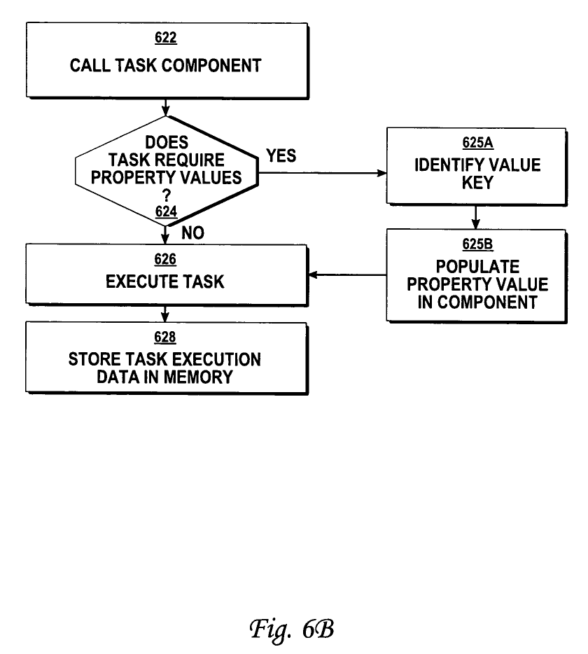

Referring now to FIG. 6A, a flow diagram illustrating the execution of an Interaction component is shown according to one embodiment. At step 602, Driver 102 begins the installation process by calling the interaction component for execution. According to one embodiment, the interaction component is an instance of a Java object, and calling the interaction component causes the instance of the Java object to be passed to a JVM for execution. When the interaction component is called, at step 604, Driver 102 will populate any required messages in the interaction component by replacing the message key identified in the interaction component with the message value corresponding to the message key. In one embodiment, Driver 102 determines which message value corresponds to a particular message key by examining a message properties file, which may be stored on a storage device of System 100 such as Memory 104. Alternatively, the message properties file may be stored on any other storage medium accessible to system 100.

At step 606, the message is displayed to the user and Driver 102 receives the input relating to the message. According to one embodiment, the user input is then validated at step 608 and 610, where Driver 102 calls any associated validator components, as referenced in the metadata, and determines whether the input is valid. If so, at step 612, Driver 102 may store the input in memory for future reference. However, if the input is not valid, at step 611, Driver 102 may cause an error message to be displayed, and proceed to step 602 to reset the interaction component so that the user may correct the error.

Referring back to step 606, the user input may alternatively represent an option call. One such option may be an option to exit the installer. Thus, at step 607, the driver determines if the input is an option call and processes the option at step 609A. According to one embodiment, Driver 102 determines, at step 609B whether the option is an exit option. If so, at 609C, the Driver 102 stops the progress of the installation and exits the user from the framework. At this point, the driver may store information relating to the progress of the installation. If Driver 102 determines that the option is not an exit option, Driver 102 returns to step 602 to continue the installation process.

In another embodiment, the input required for the particular interaction may be located in a response file, which was previously generated by the system or an administrator in order to facilitate the automatic installation of a product without user interaction.

For instance, suppose that a particular program was previously installed on Server 115 by a first Client 120A. When Driver 102 executed interaction components during the installation of the software product for Client 120A, according to one embodiment, user-input was received for each interaction. User-input in response to the execution of each interaction component may be stored and associated with the respective interaction component in the response file. For instance, once all interactions have been executed for a particular installation, Driver 102 can cause all associated user-input to be stored in a response file on system 100.

If the same program were to be installed for Client 120B, and if the installation for Client 120B required the same user-input, Driver 102 can institute a “silent” install by referring to the response file for user-input. For instance, instead of causing the interaction to be displayed to a user of system 100, Driver 102 can retrieve the user-input from the response file and place the input in memory 104. The user-input in Memory 104 is then used by Driver 102 to populate property values for task components as described below. Hence, Driver 102 may skip executing interaction components and run a “silent” install by referring to a response file for user-input. Further, in other embodiments, a system administrator may edit the response file using a text editor in order to customize the silent installation of a software product.

Referring now to FIG. 6B, a flow diagram illustrating the execution of a task component is shown according to one embodiment. At step 622, Driver 102 calls a task component for execution. Note that while the task component was being created from the task metadata, particular property value keys were placed into the executable task component representing values to be passed or processed by the task. According to one embodiment, the one or more property values are supplied by user-input in response to the execution of an interaction component. Thus, at step 624, Driver 102 will determine whether the task component requires any property values for execution. For instance, if the task component contains a property key or placeholder, Driver 102 can determine that a property value is required. If a property value is not required because no property value keys are recognized, the process proceeds to step 626, and Driver 102 executes the instructions of the task component.

However, in another embodiment, if Driver 102 determines that a property value is required for execution of the task component, at step 625A, Driver 102 will find and identify the property value key located within the task component. As mentioned earlier, the property value key may be placed in a property value placeholder. Once the property value key is identified, Driver 102 searches for the corresponding property value, for instance, in a property value file or within memory.

Assume that a particular property value was supplied by a user in response to the execution of an interaction component. When the value is received from the user and validated, the value is stored in memory 104 and associated with a particular property value key. Thus, when Driver 102 is searching for the corresponding property value, Driver 102 uses the particular property value key to determine which property value in memory to use. Once found, at step 625, Driver 102 populates the property value placeholder of the task component with the correct property value. Using this property value, the task component proceeds to step 626 to execute the task.

At step 628, once the task component has been executed, Driver 102 causes task execution data corresponding to the executed task to be stored in memory. The task execution data may identify, for instance, particular steps that the Driver 102 performed during execution of the particular task. In another embodiment, the task execution data may also identify the property values used during execution of the task, as well as any errors encountered during execution.

Using the task execution data, Driver 102 may identify all tasks which have been executed during the installation of a product. According to one embodiment, Driver 102 may use the task execution data to rollback any changes caused by executing the tasks during installation. For instance, suppose that during installation the execution of a particular task fails. At this point, the Driver 102 may request input from a user to determine if the installation should be continued or whether to exit or rollback the entire installation. If the user chooses to rollback the entire installation, all tasks executed up until the failed task will be rolled back into their original state, that is, before execution. Once all tasks have been rolled back the system will be in its original state before the installation started. Alternatively, if the user wishes to continue with the installation, Driver 102 will proceed to the next task while making note of the error within the task execution data.

Note that once a product has been fully installed on system 100 using the generic product configuration framework, the framework is actively involved in monitoring the product across multiple clients. Further, according to one embodiment, the generic product configuration framework includes multiple system tools, such as the generation and encryption of passwords, the debugging of errors within software programs and user-license management. Thus, the generic product configuration framework not only provides multi-platform support for multiple software products, but also acts as a tools framework for providing additional features and capabilities for users and developers of software products. The generic nature of the generic product configuration framework allows an installer to be customized to the lowest possible granular level. Specifically, because the individual components of an installer have been generalized, the definitions of the components are platform-independent, thus making the generic product configuration framework functional for any type of software or operating system.

### Hardware Overview

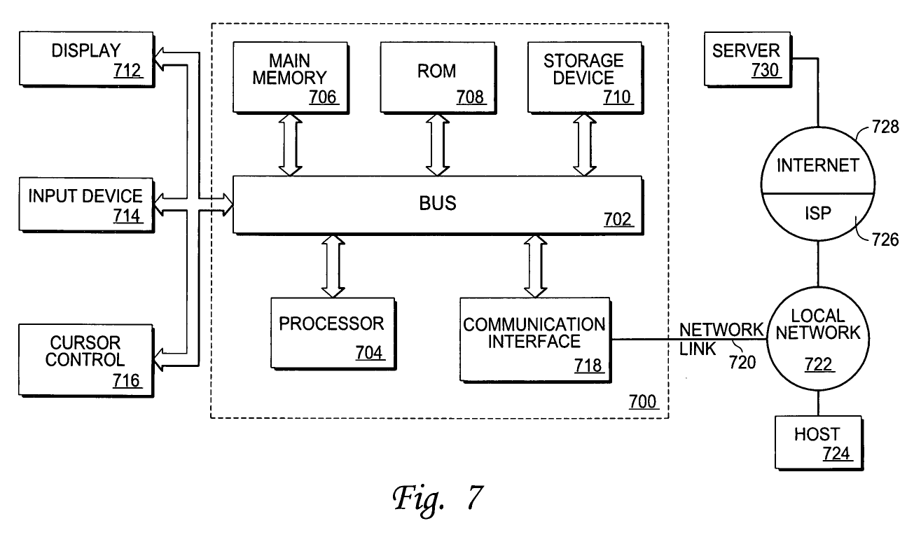

FIG. 7 is a block diagram that illustrates a computer system 700 upon which an embodiment of the invention may be implemented. Computer system 700 includes a bus 702 for facilitating information exchange, and one or more processors 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions by processor 704. Computer system 700 may further include a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712 for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

In computer system 700, bus 702 may be any mechanism and/or medium that enables information, signals, data, etc., to be exchanged between the various components. For example, bus 702 may be a set of conductors that carries electrical signals. Bus 702 may also be a wireless medium (e.g. air) that carries wireless signals between one or more of the components. Bus 702 may further be a network connection that connects one or more of the components. Any mechanism and/or medium that enables information, signals, data, etc., to be exchanged between the various components may be used as bus 702.

Bus 702 may also be a combination of these mechanisms/media. For example, processor 704 may communicate with storage device 710 wirelessly. In such a case, the bus 702, from the standpoint of processor 704 and storage device 710, would be a wireless medium, such as air. Further, processor 704 may communicate with ROM 708 capacitively. Further, processor 704 may communicate with main memory 706 via a network connection. In this case, the bus 702 would be the network connection. Further, processor 704 may communicate with display 712 via a set of conductors. In this instance, the bus 702 would be the set of conductors. Thus, depending upon how the various components communicate with each other, bus 702 may take on different forms. Bus 702, as shown in FIG. 7, functionally represents all of the mechanisms and/or media that enable information, signals, data, etc., to be exchanged between the various components.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 700, various machine-readable media are involved, for example, in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, DVD, or any other optical storage medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

At this point, it should be noted that although the invention has been described with reference to a specific embodiment, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims and the equivalents thereof.

What is claimed is:

1. A machine implemented method for configuring a computer program, comprising:
processing a set of metadata, wherein the metadata includes one or more sets of interaction metadata specifying one or more interactions to conduct with a user to obtain input therefrom and one or more sets of task metadata specifying one or more tasks to be performed to configure the computer program, and wherein the metadata specifies execution relationships between the one or more sets of interaction metadata and the one or more sets of task metadata;
creating, for each set of interaction metadata and task metadata, an executable component to give rise to a plurality of interaction components and task components;
organizing the interaction components and task components into an execution data structure in accordance with the execution relationships specified in the metadata; and
causing the interaction components and task components to be executed in accordance with the execution data structure to configure the computer program.

2. The method of claim 1, wherein each set of interaction metadata further specifies a reference to one or more messages and wherein causing one or more interaction components to be executed includes causing the one or more messages to be displayed to the user.

3. The method of claim 1, wherein each set of task metadata further specifies a reference to a particular class for creating an executable component from the metadata, and wherein the particular class provides a set of properties for creating executable components associated with the particular class.

4. The method of claim 1, wherein one or more sets of interaction metadata further specifies one or more validations to perform on user input associated with the specified interaction, and wherein the method further comprises:
creating, for each specified validation to perform, a validation component; and
organizing the one or more validation components into the execution data structure in accordance with the execution relationships specified in the metadata.

5. The method of claim 4, further comprising:
in response to causing an interaction component to be executed, receiving input data for configuring the computer program; and
validating the input data by causing one or more validation components to be executed.

6. The method of claim 5, wherein receiving input data includes retrieving the input data from a persistent storage of the computer system without any interaction from a user.

7. The method of claim 1, further comprising the steps of:
in response to causing a task component to be executed, determining that an error has occurred with respect to the task component; and
causing the system to reverse any changes caused by the execution of any task component that was previously executed.

8. The method of claim 1, wherein causing the interaction components and task components to be executed causes the computer system to install a product for a first time.

9. The method of claim 8, further comprising:
determining that the computer system has installed the product for the first time on the computer system using a first set of executable components; and
causing a sub-set of the first set of the executable components to be executed to cause the product to be installed on the computer system for a second time on the computer system.

10. The method of claim 9, wherein:
the product is installed for a first time on behalf of a first client of the computer system; and
the product is installed for a second time on behalf of a second different client of the computer system.

11. A machine-readable medium comprising a set of instructions which, when executed by one or more processors, causes the one or more processors to perform the following operations:
processing a set of metadata, wherein the metadata includes one or more sets of interaction metadata specifying one or more interactions to conduct with a user to obtain input therefrom and one or more sets of task metadata specifying one or more tasks to be performed to configure the computer program, and wherein the metadata specifies execution relationships between the one or more sets of interaction metadata and the one or more sets of task metadata;
creating, for each set of interaction metadata and task metadata, an executable component to give rise to a plurality of interaction components and task components;
organizing the interaction components and task components into an execution data structure in accordance with the execution relationships specified in the metadata; and
causing the interaction components and task components to be executed in accordance with the execution data structure to configure the computer program.

12. The machine-readable medium of claim 11, wherein each set of interaction metadata further specifies a reference to one or more messages and wherein causing one or more interaction components to be executed includes causing the one or more messages to be displayed to the user.

13. The machine-readable medium of claim 11, wherein each set of task metadata further specifies a reference to a particular class for creating an executable component from the metadata, and wherein the particular class provides a set of properties for creating executable components associated with the particular class.

14. The machine-readable medium of claim 11, wherein one or more sets of interaction metadata further specifies one or more validations to perform on user input associated with the specified interaction, and wherein the set of instructions causes the one or more processors to further perform the following operations:
creating, for each specified validation to perform, a validation component; and
organizing the one or more validation components into the execution data structure in accordance with the execution relationships specified in the metadata.

15. The machine-readable medium of claim 14, wherein the set of instructions causes the one or more processors to further perform the following operations:
in response to causing an interaction component to be executed, receiving input data for configuring the computer program; and
validating the input data by causing one or more validation components to be executed.

16. The machine-readable medium of claim 15, wherein receiving input data includes retrieving the input data from a persistent storage of the computer system without any interaction from a user.

17. The machine-readable medium of claim 11, wherein the set of instructions causes the one or more processors to further perform the following operations:
in response to causing a task component to be executed, determining that an error has occurred with respect to the task component; and
causing the system to reverse any changes caused by the execution of any task component that was previously executed.

18. The machine-readable medium of claim 11, wherein causing the interaction components and task components to be executed causes the computer system to install a product for a first time on the system.

19. The machine-readable medium of claim 18, wherein the set of instructions causes the one or more processors to further perform the following operations:
determining that the computer system has installed the product for the first time on the computer system using a first set of executable components; and
causing a sub-set of the first set of the executable components to be executed to cause the product to be installed on the computer system for a second time on the computer system.

20. The machine-readable medium of claim 19, wherein:
the product is installed for a first time on behalf of a first client of the computer system; and
the product is installed for a second time on behalf of a second different client of the computer system.

21. An apparatus, comprising:
A persistent storage;
One or more processors; and
A set of instructions, which when executed by the one or more processors, causes the one or more processors to perform the following operations:
processing a set of metadata, wherein the metadata includes one or more sets of interaction metadata specifying one or more interactions to conduct with a user to obtain input therefrom and one or more sets of task metadata specifying one or more tasks to be performed to configure the computer program, and wherein the metadata specifies execution relationships between the one or more sets of interaction metadata and the one or more sets of task metadata;
creating, for each set of interaction metadata and task metadata, an executable component to give rise to a plurality of interaction components and task components;
organizing the interaction components and task components into an execution data structure in accordance with the execution relationships specified in the metadata; and
causing the interaction components and task components to be executed in accordance with the execution data structure to configure the computer program.

22. The apparatus of claim 21, wherein each set of interaction metadata further specifies a reference to one or more messages and wherein causing one or more interaction components to be executed includes causing the one or more messages to be displayed to the user.

23. The apparatus of claim 21, wherein each set of task metadata further specifies a reference to a particular class for creating an executable component from the metadata, and wherein the particular class provides a set of properties for creating executable components associated with the particular class.

24. The apparatus of claim 21, wherein one or more sets of interaction metadata further specifies one or more validations to perform on user input associated with the specified interaction, and wherein the method further comprises:
creating, for each specified validation to perform, a validation component; and
organizing the one or more validation components into the execution data structure in accordance with the execution relationships specified in the metadata.

25. The apparatus of claim 24, further comprising:
in response to causing an interaction component to be executed, receiving input data for configuring the computer program; and
validating the input data by causing one or more validation components to be executed.

26. The apparatus of claim 25, wherein receiving input data includes retrieving the input data from a persistent storage of the computer system without any interaction from a user.

27. The apparatus of claim 21, further comprising:
in response to causing a task component to be executed, determining that an error has occurred with respect to the task component; and
causing the system to reverse any changes caused by the execution of any task component that was previously executed.

28. The apparatus of claim 21 wherein causing the interaction components and task components to be executed causes the computer system to install a product for a first time on the system.

29. The apparatus of claim 28, further comprising:
determining that the computer system has installed the product for the first time on the computer system using a first set of executable components; and
causing a sub-set of the first set of the executable components to be executed to cause the product to be installed on the computer system for a second time on the computer system.

30. The apparatus of claim 29, wherein:
the product is installed for a first time on behalf of a first client of the computer system; and
the product is installed for a second time on behalf of a second different client of the computer system.
